(19) United States
(12) Patent Application Publication
(10) Pub. No.: US 2023/0045922 A1
(43) Pub. Date: Feb. 16, 2023

(54) System, Vehicle and Method for Adaptive Cruise Control

(71) Applicant: Robert Bosch GmbH, Stuttgart (DE)

(72) Inventors: Lijuan Zhu, Jiangsu (CN); Xueqian Zhu, Jiangsu (CN); Gen Liang, Jiangsu (CN); Songyan Shen, Jiangsu (CN)

(21) Appl. No.: 17/814,430

(22) Filed: Jul. 22, 2022

(30) Foreign Application Priority Data
Aug. 2, 2021 (CN) 202110879729.0

(51) Int. Cl. B60W 30/16; B60W 30/14; B60W 40/04; B60W 40/105; B60W 10/18

(52) U.S. Cl. CPC B60W 30/162; B60W 30/146; B60W 40/04; B60W 40/105; B60W 10/18; B60W 2420/42; B60W 2420/52; B60W 2554/4045; B60W 2554/801; B60W 2554/802

(57) ABSTRACT

An adaptive cruise control system includes an information acquisition unit having a main detector and a secondary detector, a control unit, and an execution unit. The main detector detects an object located ahead of the vehicle. The control unit determines whether control of the vehicle is required depending on an actual value determined by the main detector and the threshold value of a system property characterizing the driving environment. The execution unit controls the vehicle. The secondary detector is arranged such that its field of view for detecting an object located at an angle ahead of the vehicle covers the boundary of the main detector's field of view, and which is oriented outwards in relation to the forward direction of the vehicle. The secondary detector sends an indication signal to adjust the threshold value of the system property when an object is detected.

This application claims priority under 35 U.S.C. § 119 to application no. CN 202110879729.0, filed on Aug. 2, 2021 in China, the disclosure of which is incorporated herein by reference in its entirety.

### TECHNICAL FIELD

The disclosure concerns the field of adaptive cruise control for vehicles, specifically a system, a vehicle, and a method for adaptive cruise control, and in particular a new design, wherein an indication is sent by means of a front corner radar when another vehicle approaches in the lane or pushes in during adaptive cruise control.

### BACKGROUND

A front central radar of a vehicle has a field of view of ±120° and a front camera has a field of view of ±100°. The two sensors cannot detect an object or target located at the boundary of the field of view. This leads to the fact that the front central radar may lose tracking or detection of a vehicle if the vehicle enters the lane or pushes in. This results in a high risk of collision.

In the patent application with the published application number CN 112389429 A, a control method for adaptive cruise control, an adaptive cruise control system, a vehicle and a computer-readable memory medium are provided, wherein a pressing time is determined when the pressing of a push button for a main switch is detected; it is determined whether the pressing time is longer than or equal to a first specified time threshold; and in response to the pressing of the push button for the main switch, adaptive cruise control is activated when the pressing time is longer than or equal to the first specified time threshold. For example, adaptive cruise control can be quickly activated by pressing a push button, so that the vehicle can quickly initiate the adaptive cruise control, which is more favorable and more immediate compared to pressing a push button twice.

### SUMMARY

In various aspects, the object of the disclosure is to give the adaptive cruise control system of the vehicle a capability in a simple way in order to avoid the risk of collision in the event of another vehicle at an angle ahead of the subject vehicle approaching (or pushing in).

The object of the disclosure is also to solve or mitigate the other problems in the prior art.

With the disclosure, the object is achieved by a system, vehicle, and method for adaptive cruise control. In particular, in one aspect of the disclosure, an adaptive cruise control system is provided for a vehicle, wherein the adaptive cruise control system comprises an information acquisition unit, a control unit and an execution unit that are connected to each other in a communicative manner. The information acquisition unit comprises a main detector for the detection of an object ahead of the vehicle. In the adaptive cruise control system, a threshold value of a system property characterizing the driving environment is set. An actual value of the system property is determined by the main detector. The control unit is designed to determine whether control of the vehicle is required depending on the actual value of the system property and the threshold value of the system property. The execution unit controls the vehicle according to an instruction of the control unit. The information collection unit also includes a secondary detector. The secondary detector is arranged in such a way that its field of view for the detection of an object located at an angle ahead of the vehicle covers the boundary of the field of view of the main detector and is oriented outwards in relation to the forward direction of the vehicle. The secondary detector is designed to provide an indication signal for adjusting the threshold value of the system property when an object is detected.

In a further aspect of the disclosure, a vehicle is provided which is equipped with an adaptive cruise control system described above.

In another aspect of the disclosure, a method for avoiding a collision with an object while driving a vehicle is provided. The method is performed by an adaptive cruise control system described above and includes the following steps:

S1: Detection of an object at an angle ahead of the vehicle by the secondary detector;
S2: Sending an indication signal to adjust the threshold value of the system property when the object is detected in step S1;
S3: Determining by the control unit whether control of the vehicle is required depending on the actual value of the system property and an adjusted threshold value of the system property; if so, progress to step S4; and if not, return to step S1;
S4: Controlling the vehicle by the execution unit according to an instruction of the control unit and returning to step S1.

### BRIEF DESCRIPTION OF THE DRAWINGS

The aforementioned and other features of the present disclosure are made clearer by reference to the attached drawings. In the Figures:

FIG. 1 shows a schematic representation of an adaptive cruise control system according to the disclosure;

FIG. 2 shows a schematic representation of a vehicle according to the disclosure;

FIG. 3 shows a schematic representation of an application scenario according to the disclosure; and

FIG. 4 shows a flowchart of a method according to the disclosure.

### DETAILED DESCRIPTION

FIG. 1 shows a schematic representation of an adaptive cruise control system 100 according to the disclosure. Because the specific shapes of the individual components and the connections between them do not form part of the subject-matter of the disclosure, for the sake of clarity all components are presented in the form of blocks. A person skilled in the art can independently select the appropriate shapes and connections with the help of this block diagram. In addition, the block diagram displayed is only an example of the disclosure. A person skilled in the art can make different modifications taking into account the diagram without deviating from the spirit of the disclosure, and these modifications should also be included in the scope of protection of the disclosure.

An adaptive cruise control (ACC) system for a vehicle is also known as an intelligent adaptive cruise control system and is used to assist the driver while driving. In particular, depending on the information from various on-board sensors (such as the distance and speed relative to a vehicle ahead), it can increase the speed in the longitudinal direction of the vehicle by controlling the accelerator pedal or the brake of the vehicle and can maintain an appropriate safety distance from the vehicle ahead so that the load on the driver of the vehicle is reduced, the active safety of the vehicle is increased and the scope of the adaptive cruise control is increased.

The adaptive cruise control system 100 comprises an information acquisition unit 1, a control unit 2 and an execution unit 3, which are connected to each other in a communicative manner. In the adaptive cruise control system 100, a threshold value of a system property characterizing the driving environment is set. The driving environment (also driving conditions or driving states) includes, for example, the speed of the vehicle, the distance to another vehicle straight ahead, at an angle ahead, to the side, or straight behind, the speed and acceleration of the other vehicle, etc. The system properties refer to the criteria for this driving environment and, in addition to the speeds, accelerations and distances mentioned above, can also include the probability of an obstacle, the probability of presence, distances in the longitudinal and lateral directions, velocities in the longitudinal and lateral directions, the variance of the speeds in the lateral direction, etc. The threshold values of these system properties are pre-stored in the adaptive cruise control system 100 in order to be compared later with the actual driving environment obtained by the information acquisition unit 1 for appropriate control. The selecting or setting of the thresholds can be carried out according to the model of the vehicle and the experience of a person skilled in the art. For example, it can be done by the driver through a human-machine interface mounted on the dashboard of the vehicle.

The information acquisition unit 1 represents a window for the vehicle to perceive the outside environment, so that it can determine the current driving environment or driving conditions or driving states. The information acquisition unit 1 may include on-board sensors, such as a radar sensor, a speed sensor, and a valve position sensor. In this example, the information acquisition unit 1 comprises a main detector 11 for the detection of an object ahead of the vehicle. The object is in the narrow sense another vehicle, but it can also be in the wider sense either a moving object, such as a motorcycle, bicycle, electric bicycle, and pedestrian, or even a stationary object. In this example, the main detector 11 is used to send the obtained acquired information, i.e. the current values of the system properties, to the control unit 2.

The control unit 2 can, for example, in particular be an electronic control unit (ECU), which usually contains a microprocessor and various circuits to achieve control of the entire adaptive cruise control system. As described above, the control unit 2 can determine, depending on the information collected by the main detector 11 and the threshold values of the system properties, whether control of the vehicle is required. For example, if the threshold value of the system property is the safety distance between the vehicle and a vehicle ahead and the current distance between the vehicle and the vehicle ahead obtained by the main detector 11 is smaller than the set safety distance, the ECU can calculate a proportion of the current distance to the safety distance and the magnitude of the relative speed resulting from the difference between the speed of the vehicle provided by a speed sensor of the vehicle and the speed of the vehicle ahead obtained by the main detector 11 in order to obtain a braking method for the vehicle. A corresponding control signal or command is then sent to the execution unit, by which any control of the vehicle is carried out. At the same time, the control unit can warn the driver through an alarm system that he should take appropriate measures, which will further improve driving safety.

The execution unit 3 controls the vehicle according to an instruction of the control unit 2. The control includes acceleration, braking and/or deflection, but is not necessarily limited to longitudinal control. The execution unit comprises, for example, a valve actuator used to adjust the degree of opening so that the vehicle accelerates, decelerates, or drives at a constant speed, and a brake actuator, which brakes the vehicle in the event of an emergency.

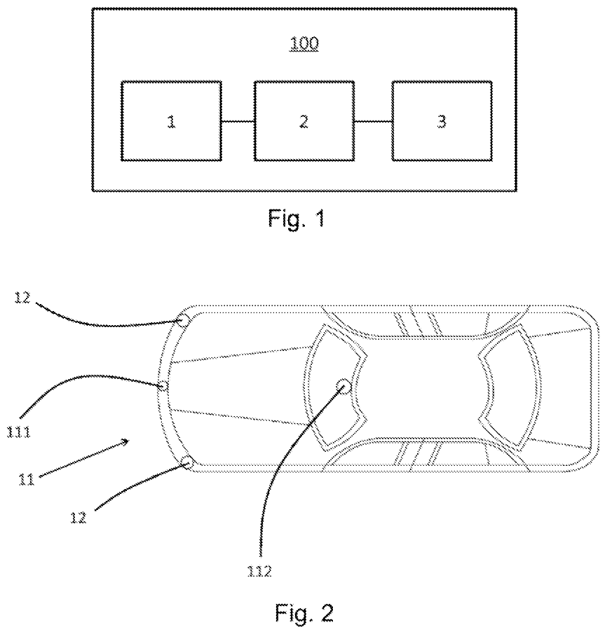

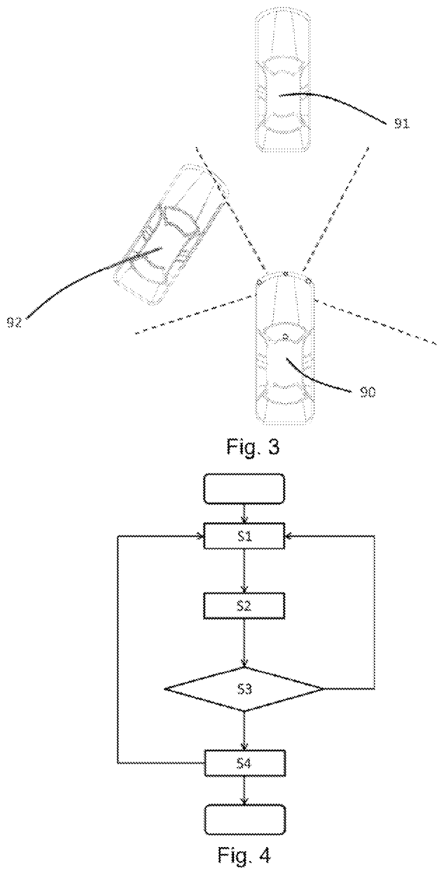

FIG. 2 or FIG. 3 shows a schematic representation of a vehicle or an application scenario according to the disclosure.

To overcome the safety risk posed by the blind zone of a detector used to detect an object ahead of the vehicle and to improve the detection capability of the vehicle for an object at an angle ahead of the vehicle, the information acquisition unit 1 further comprises a secondary detector 12. The secondary detector 12 is arranged in such a way that its field of view for the detection of an object at an angle ahead of the vehicle covers the boundary of the field of view of the main detector 11 and is oriented outwards relative to the forward direction of the vehicle. Due to such an arrangement of the secondary detector 12, the total scope of detection of the detectors of the vehicle is increased and the limitation with regard to the range of the front detector is mitigated. The secondary detector 12 sends an indication signal for adjustment of the threshold value of the system property when an object is detected. Once the threshold has been adjusted, the result of the control unit 2 comparison between the threshold value and the current actual driving condition can vary. Therefore, if necessary, the vehicle is controlled by the execution unit 3 according to the new comparison result.

In a typical application from FIG. 3, the vehicle 90 is located in a central lower part of the Figure, a vehicle ahead 91 in a central upper part of the Figure, and a lateral vehicle 92 at an angle ahead of the vehicle 90 in a left central part of the Figure. In addition, in FIG. 3, the scope of detection of the main detector 11 alone and the scope of detection of the main detector 11 including that of the secondary detector 12 are each shown with a dashed line. It can be seen that the lateral vehicle 92 is at the limit of the detection range of the main detector 11, so that the main detector 11 can only detect the lateral vehicle 92 to a limited extent. In particular, the main detector 11 determines a low probability that the lateral vehicle 92 is an obstacle or is present. On the other hand, the scope of detection of the main detector 11 together with that of the secondary detector 12 can easily cover the lateral vehicle 92 without limitation.

In an initial state, a target of the adaptive cruise control system 100 is the vehicle ahead 91, and according to an initial threshold for the safety distance the vehicle 90 always maintains a safe distance from the vehicle ahead 91. At this time, the lateral vehicle 92 wants to enter the lane of the vehicle 90 or push in. If the vehicle 90 is only equipped with the front detector (such as a front central radar and/or a front camera), the limitation at the boundary of this detector could lead to a timely detection and determination of the lateral vehicle 92 only taking place with difficulty, which could lead to delayed initiation of a suitable measure. In this example, because of the design of the secondary detector 12 the presence of the lateral vehicle 92 is detected ahead of time and the indication signal is sent to adjust the threshold value of the system property. For example, the threshold value for the probability of an obstacle or the probability of presence, the value of which is determined by the main detector 11, is reduced compared to the initial state, i.e. a lower threshold for determining an obstacle is set. In other words, in this case, due to the main detector 11 the adaptive cruise control system 100 can more easily rule out the presence of an obstacle. So the adaptive cruise control system 100 can switch the tracked target to the lateral vehicle 92 in a more timely manner and take the appropriate measure. The measure can include braking or changing lanes to the right if it is determined that there is no other object on the right side and diagonally behind it on the right side. The determination of the current value of the probability of an obstacle or the probability of presence is specified by the main detector 11. For example, an object that has an intensity received by the main detector 11 equal to or greater than a given level may be considered an object with a high probability of presence. On the other hand, an object which cannot be detected by the main detector 11 or which has an intensity received by the main detector which is less than the given level, may be viewed as an object with a low probability of presence.

In this way, the adaptive cruise control system of the vehicle is given the ability to avoid the risk of collision when another vehicle at an angle ahead of that vehicle approaches (or pushes in). If the secondary detector 12 is included, the current value of the system property is obtained in particular by the already existing main detector 11. Therefore, no renewed complicated fusion of the secondary detector 12 and the main detector 11 is required (the fusion of the detectors, simply put, means a uniform, interacting calibration of the collected data of the individual sensors so that they work as a whole and deviations are avoided, and the fusion can include radar fusion, camera fusion and radar camera fusion). Even with a successful fusion, the newly composed detection unit requires more computing power at work due to a larger number of detectors, and it puts more load on the bus, which is time-consuming. Therefore, in the present embodiment with the information acquisition units and fusion states remaining the same, the secondary detectors are used “seamlessly” and the ability to effectively counteract the approach or pushing in of a vehicle located at an angle ahead can be imparted. This provides a compatible, versatile, and cost-effective solution.

As mentioned above, the main detector 11 and/or the secondary detector 12 may be in the form of a radar or camera, which is also referred to as a webcam. In particular, they can also be in the form of a millimeter wave radar in order to achieve a higher resolution and anti-interference capability and thus to make possible the adaptive cruise control of the vehicle in all weathers.

In a typical arrangement, the secondary detector 12 is formed on a headlight of the vehicle and arranged at an angle of 45° outwards relative to the forward direction of the vehicle, and the main detector 11 is arranged centrally on the front of the vehicle.

This design of the secondary detector 12 and the main detector 11 uses the detection ranges of the individual detectors to cover the entire detection range of the detectors to a large extent and to keep the number of detectors required low at the same time, which saves costs.

As shown in FIG. 2, the main detector 11 includes a front central radar 111 and a camera 112. The front central radar 111 is arranged centrally on the front of the vehicle and the camera 112 is arranged on an interior rear-view mirror. In this design, the front central radar 111 together with the camera 112 detects an object ahead of the vehicle (this is why they are also ready for fusion). As a result, the advantage of the camera, i.e. a vision-based detection, and the advantage of the radar, i.e. the interference suppression, the all-weather operation, and the commonplace nature, can be obtained at the same time.

With regard to the specific method of communication, the communication of the adaptive cruise control system 100 can be carried out by a CAN bus of the vehicle. For example, the secondary detector 12 sends the indication signal to the CAN bus when an object at an angle ahead is detected in order to achieve data transmission with high performance, in real time and with reliability.

It can be seen from this that the adjustment of the sensitivity of the main detector is enabled by changing the parameters of the adaptive cruise control system. In other words, by changing the parameters, the main detector 11 can switch between a general far-field mode and a near-field mode with higher sensitivity at the boundaries. For example, the main detector 11 monitors the indication signal of the secondary detector 12, and the change between operating modes of the main detector 11 is achieved by adjusting the parameters. The threshold values can be stored in the main detector 11.

In addition to the vehicle located at an angle ahead, the information acquisition unit 1 may also include other secondary detectors located in a central part and/or at the rear of the vehicle 12 to avoid the risk of collision with vehicles in other positions. With regard to the design and characteristics of the other secondary detectors 12, the above description for the vehicle at an angle ahead can be used. It should be noted that the control unit 2 should be able to obtain a solution for the simultaneous avoidance of multiple vehicles if the multiple vehicles each appear with a known risk of collision in each direction. For example, when a vehicle pushes in from the left side, a number of solutions are obtained, such as a lane change to the right and/or braking, whereas when both a vehicle from the left side and a vehicle from the right side push in, only braking is obtained as a solution.

In addition to the probability of an obstacle and the probability of presence mentioned in connection with FIG. 3, the system properties can also determine the probability of movement, the distances in the longitudinal and lateral directions, the speeds in the longitudinal and lateral directions, the variance of speeds in the lateral direction, the lane, and the lateral distance between a target and a trajectory of the vehicle. The distances in the longitudinal and lateral directions represent the distances between the target object and the vehicle in the longitudinal and lateral directions, and the speed in the lateral direction represents the speed of the target object relative to the vehicle in the lateral direction. The specific idea for adjustment is similar to that for the probability of an obstacle and the probability of presence. For example, if the secondary detector 12 detects a vehicle located at an angle ahead, the threshold value for the distances in the longitudinal and lateral directions in the main detector 11 is increased and the threshold value for the speed in the lateral direction is reduced in order to improve the sensitivity of the main detector 11 for an affected vehicle and thus to initiate action ahead of time. It is to be understood that the variance reflects a measure of the scattering of a variable (in this case the speed in the lateral direction) and that the consideration of the variance is used to eliminate outliers, which results in improved accuracy and stability of detection. The threshold values of the system properties can be taken into account at the same time and increased or reduced to increase the sensitivity. Since the specific adjustment of the threshold values of the system properties is not a focus of the disclosure, this is not discussed further here.

In a further aspect of the disclosure, the disclosure also relates to a vehicle equipped with an adaptive cruise control system 100 described above. The vehicle can be a petrol vehicle, diesel vehicle, car, commercial vehicle, bus, hybrid vehicle or purely electric vehicle.

FIG. 4 shows a flowchart of a method according to the disclosure.

The method is used to avoid a collision with an object while driving a vehicle. The method is performed by an adaptive cruise control system 100 described above and includes the following steps:

S1: Detection of an object located at an angle ahead of the vehicle by the secondary detector 12;
S2: Sending an indication signal to adjust the threshold of the system property when the object is detected in step S1;
S3: Determination by the control unit 2 whether control of the vehicle is required depending on the actual value of the system property and an adjusted threshold value of the system property; if so, progress to step S4; and if not, return to step S1;
S4: Control of the vehicle by the execution unit 3 according to an instruction of the control unit 2 and return to step S1. In addition, it should be understood that the rounded block ahead of S1 in the figure represents a start symbol and the rounded block after S4 represents an end symbol.

With regard to the design of the method, reference may be made to the above description of the adaptive cruise control system 100. This is not discussed in more detail here. However, it should be noted that according to the execution of the present method, a different indication signal should be sent if the secondary detector 12 does not detect an object, i.e. it is excluded that the probability of the existence of the object is too low. This indication signal is used to set the threshold of the system property back to the original level to avoid hypersensitivity of the adaptive cruise control system 100 to the objects in the environment.

It is to be understood that the embodiments preferred above are exemplary, but not restrictive. The modifications and changes of the specific exemplary embodiments described above, prepared by a person skilled in the art taking into account the idea of the present disclosure, should be included in the scope of protection of the present disclosure.

What is claimed is:

1. An adaptive cruise control system for a vehicle, the adaptive cruise control system comprising:
an information acquisition unit having:
a main detector configured to detect an object located ahead of the vehicle, a threshold value of a system property characterizing a driving environment being set and the main detector being configured to determine an actual value of the system property; and
a secondary detector arranged such that its field of view for detecting an object located at an angle ahead of the vehicle covers a boundary of a field of view of the main detector and oriented outwards in relation to a forward direction of the vehicle, the secondary detector being configured to send an indication signal to adjust the threshold value of the system property in response to an object being detected;
a control unit configured to determine, depending on the actual value of the system property and the threshold value of the system property, whether control of the vehicle is required; and
an execution unit configured to control the vehicle in accordance with an instruction of the control unit,
wherein the information acquisition unit, the control unit, and the execution unit are are interconnected in a communicative manner.

2. The adaptive cruise control system according to claim 1, wherein at least one of the main detector and the secondary detector is one of a radar and camera.

3. The adaptive cruise control system according to claim 2, wherein the main detector and the secondary detector are millimeter wave radars.

4. The adaptive cruise control system according to claim 1, wherein at least one of:
the secondary detector is formed on a headlight of the vehicle and is arranged at an angle of 45° outwards in relation to the forward direction of the vehicle; and
the main detector is located centrally on a front of the vehicle.

5. The adaptive cruise control system according to claim 1, wherein the system property includes at least one of (i) a probability of an obstacle, (ii) a probability of presence, (iii) a probability of movement, (iv) distances in a longitudinal direction and a lateral direction, (v) speeds in the longitudinal direction and the lateral directions, (vi) a variance of the speeds in the lateral direction, (vii) a lane, and (viii) a lateral distance between a target and a trajectory of the vehicle.

6. The adaptive cruise control system according to claim 1, wherein the main detector includes a front central radar and a camera, the front central radar being arranged on a front of the vehicle and the camera being arranged on an interior rear-view mirror.

7. The adaptive cruise control system according to claim 1, wherein communication of the adaptive cruise control system is carried out by a CAN bus of the vehicle.

8. The adaptive cruise control system according to claim 1, wherein the information acquisition unit includes further secondary detectors arranged at least one of in a central part of the vehicle and at a rear of the vehicle.

9. The adaptive cruise control system according to claim 1, wherein the control of the vehicle by the execution unit includes at least one of acceleration, braking, and deflection.

10. A vehicle comprising:
an adaptive cruise control system, the adaptive cruise control system comprising:
an information acquisition unit having (i) a main detector configured to detect an object located ahead of the vehicle, a threshold value of a system property characterizing a driving environment being set and the main detector being configured to determine an actual value of the system property, and (ii) a secondary detector arranged such that its field of view for detecting an object located at an angle ahead of the vehicle covers a boundary of a field of view of the main detector and oriented outwards in relation to a forward direction of the vehicle, the secondary detector being configured to send an indication signal to adjust the threshold value of the system property in response to an object being detected;
a control unit configured to determine, depending on the actual value of the system property and the threshold value of the system property, whether control of the vehicle is required; and
an execution unit configured to control the vehicle in accordance with an instruction of the control unit,
wherein the information acquisition unit, the control unit, and the execution unit are are interconnected in a communicative manner.

11. A method for avoiding a collision with an object while driving a vehicle, the vehicle having an adaptive cruise control system including an information acquisition unit, a control unit, and an execution unit that are interconnected in a communicative manner, the information acquisition unit having a main detector configured to detect an object located ahead of the vehicle, a threshold value of a system property characterizing a driving environment being set and the main detector being configured to determine an actual value of the system property, the information acquisition unit having a secondary detector arranged such that its field of view for detecting an object located at an angle ahead of the vehicle covers a boundary of a field of view of the main detector and oriented outwards in relation to a forward direction of the vehicle, the method comprising:
(S1) detecting, using the secondary detector, an object at an angle ahead of the vehicle;
(S2) sending, with the secondary detector, an indication signal to adjust the threshold value of the system property in response to the object being detected;
(S3) determining, with the control unit, whether control of the vehicle is required depending on the actual value of the system property and the adjusted threshold value of the system property, (S1) being returned to in response to determining that control of the vehicle is not required; and
(S4) controlling, with the execution unit, the vehicle according to an instruction of the control unit and returning to (S1), in response to determining that control of the vehicle being required.

12. The method according to claim 11 further comprising:
adjusting the threshold value of the system property to its original value in response to, after finishing (S4), the object not being detected in a next iteration of (S1).
